(19) United States
(12) Patent Application Publication
(10) Pub. No.: US 2021/0247255 A1
(43) Pub. Date: Aug. 12, 2021

(54) PRESSURE SENSOR

(71) Applicant: Azbil Corporation, Tokyo (JP)

(72) Inventors: Rina OGASAWARA, Tokyo (JP); Yuki SETO, Tokyo (JP); Yusuke NIIMURA, Tokyo (JP)

(73) Assignee: Azbil Corporation, Tokyo (JP)

(21) Appl. No.: 17/163,673

(22) Filed: Feb. 1, 2021

(30) Foreign Application Priority Data
Feb. 6, 2020 (JP) 2020-018574

(51) Int. Cl. G01L 9/00; G01L 19/00; G01L 15/00

(52) U.S. Cl. CPC G01L 9/0051; G01L 15/00; G01L 19/0038

(57) ABSTRACT

To correct for effects of disturbance on a pressure measurement value, a pressure sensor includes a cylindrical housing having a through-hole, a diaphragm having peripheral edge portions fixed to the housing to block the through-hole and a first surface in contact with a fluid to be measured, first strain sensor on a surface on an opposite side of the diaphragm's first surface for detecting deformation of the diaphragm, a dummy diaphragm having peripheral edge portions fixed to the housing and not making contact with the fluid, second strain sensor on a surface of the dummy diaphragm for detecting deformation of the dummy diaphragm, a correction unit for correcting output signal of the first strain sensor to eliminate effects of disturbance based on output signal of the second strain sensor, and a pressure calculation unit for converting the signal corrected by the correction unit into the fluid's pressure.

### CROSS REFERENCE TO RELATED APPLICATIONS

This patent application claims the benefit of foreign priority to Japanese Patent Application No. JP 2020-018574 filed on Feb. 6, 2020, the disclosure of which is hereby incorporated by reference in its entirety.

### BACKGROUND OF THE INVENTION

The present disclosure relates to a pressure sensor for, for example, sanitary usage.

In order for pressure sensors for detecting the pressure of a fluid to be recognized as pressure sensors for sanitary usage used at manufacturing sites for foods, pharmaceuticals, and the like that require hygienic consideration, the pressure sensors must meet strict requirements regarding reliability and the like. For this reason, pressure sensors for sanitary usage are required to have a structure (oil-free structure) that does not use an encapsulant (see PTL 1 and PTL 2).

In addition, the pressure sensor for sanitary usage has a joint (for example, a ferrule joint) in the portion connected with respect to the pipe through which the fluid to be measured flows. The connection between the pipe and the pressure sensor is achieved by a connecting member such as, for example, a clamp. As described above, in the pressure sensor connected to the pipe via a joint, the diaphragm may be deformed by disturbance and the pressure measurement value may be affected (see PTL 3 and PTL 4). Examples of disturbance include a tightening force of the clamp, vibrations of the pipe, and the like. In particular, since the diaphragm makes direct contact with the fluid to be measured in a pressure sensor for sanitary usage, the effect of disturbance is large and the reliability of the measurement degrades.

Since such effects of disturbance cannot be eliminated in conventional pressure sensors, the accuracy of pressure measurement is reduced. Such measurement states need to be improved constantly.

### CITATION LIST

### Patent Literature

[PTL 1] JP-A-2017-120214
[PTL 2] JP-A-2017-125763
[PTL 3] JP-A-2018-004591
[PTL 4] JP-A-2018-004592

### BRIEF SUMMARY OF THE INVENTION

The present disclosure addresses the problems described above with an object of providing a pressure sensor capable of correcting the effect of disturbance on the pressure measurement value.

A pressure sensor according to the present disclosure includes a cylindrical housing in which an opening is present in at least one end surface; a first diaphragm that has a peripheral edge portion fixed to an inner wall of the housing so as to block the opening and has a first surface facing and being in contact with a fluid to be measured; a first strain sensor configured to detect deformation of the first diaphragm, the first strain sensor being provided on a second surface on an opposite side of the first surface of the first diaphragm; a second diaphragm that has a peripheral edge portion fixed to the inner wall of the housing and has a first surface facing the fluid and a second surface on the opposite side of the first surface, the first surface and the second surface being not in contact with the fluid; a second strain sensor configured to detect deformation of the second diaphragm, the second strain sensor being provided on the first surface or the second surface of the second diaphragm; a correction unit configured to correct an output signal of the first strain sensor so as to eliminate an effect of disturbance based on an output signal of the second strain sensor; and a pressure calculation unit configured to convert the signal corrected by the correction unit into a pressure of the fluid.

In addition, in one structure example of the pressure sensor according to the present disclosure, the second diaphragm is provided in the housing so that the first surface of the second diaphragm faces the second surface of the first diaphragm.

In addition, in one structure example of the pressure sensor according to the present disclosure, the housing further includes an atmospheric pressure introduction path through which an atmospheric pressure is introduced into a space between the first diaphragm and the second diaphragm.

In addition, one structure example of the pressure sensor according to the present disclosure further includes a blocking member that blocks a second opening of the housing and has a first surface in contact with the fluid, a first opening and the second opening being formed in parallel with each other as the opening in the housing, in which the first diaphragm has the peripheral edge portion fixed to the inner wall of the housing to block the first opening, and the second diaphragm is provided inside the second opening so that the first surface of the second diaphragm faces a second surface on the opposite side of the first surface of the blocking member.

In addition, in one structure example of the pressure sensor according to the present disclosure, the housing further includes an atmospheric pressure introduction path through which an atmospheric pressure is introduced into a space between the second diaphragm and the blocking member.

In addition, in one structure example of the pressure sensor according to the present disclosure, a position of the first diaphragm from the one end surface of the housing in the first opening coincides with a position of the second diaphragm from the one end surface of the housing in the second opening, and the first diaphragm and the second diaphragm are disposed symmetrically with respect to an axis of the housing.

In addition, in one structure example of the pressure sensor according to the present disclosure, the first diaphragm and the second diaphragm have the same diameter and the same thickness.

In addition, in one structure example of the pressure sensor according to the present disclosure, when the output signal of the first strain sensor is V, the output signal of the second strain sensor is Vr, and the corrected output signal is Vc, the correction unit calculates the corrected output signal Vc by Vc=V−Vr or Vc=V+Vr.

In addition, in one structure example of the pressure sensor according to the present disclosure, when the output signal of the first strain sensor is V, the output signal of the second strain sensor is Vr, and the corrected output signal is Vc, the correction unit calculates the corrected output signal Vc by Vc=V−a×Vr−b−d (where a, b, and d are constants).

In addition, in one structure example of the pressure sensor according to the present disclosure, when the output signal of the first strain sensor is V, the output signal of the second strain sensor is Vr, and the corrected output signal is Vc, the correction unit calculates the corrected output signal Vc by Vc=V−b−c×Vr−d (where b, c, and d are constants).

In addition, in one structure example of the pressure sensor according to the present disclosure, when the output signal of the first strain sensor is V, the output signal of the second strain sensor is Vr, and the corrected output signal is Vc, the correction unit calculates the corrected output signal Vc by Vc=V−{(a×e+c)/(e+1)}×Vr−d (where a, c, d, and e are constants).

According to the present disclosure, it is possible to correct for the effect of disturbance on the pressure measurement value even when the pressure sensor is affected by a plurality of types of disturbance by providing a second diaphragm and a second strain sensor in addition to a first diaphragm and a first strain sensor for pressure measurement.

### BRIEF DESCRIPTION OF THE SEVERAL VIEWS OF THE DRAWING

FIG. 1 is a sectional view illustrating a pressure sensor according to a first embodiment of the present disclosure.

FIG. 2 is a plan view illustrating the pressure sensor according to the first embodiment of the present disclosure.

FIG. 3 is an external view illustrating a clamp for attaching the pressure sensor according to the first embodiment of the present disclosure to a pipe.

FIG. 4 is an external view illustrating the connection structure between the pressure sensor according to the first embodiment of the present disclosure and the pipe.

FIG. 5 is a sectional view illustrating the connection structure between the pressure sensor according to the first embodiment of the present disclosure and the pipe.

FIG. 6 is a sectional view illustrating the state in which a diaphragm of the pressure sensor has been deformed by the pressure of a fluid in the first embodiment of the present disclosure.

FIG. 7 is a diagram illustrating changes in output signals of strain sensors with respect to the pressure of the fluid.

FIG. 8 is a sectional view illustrating the state in which the diaphragm and a dummy diaphragm of the pressure sensor have been deformed by a tightening force of the clamp in the first embodiment of the present disclosure.

FIG. 9 is a diagram illustrating changes in the output signals of the strain sensors with respect to a tightening torque of the clamp.

FIG. 10 is a diagram illustrating changes in the output signals of the strain sensors with respect to the vibrations of the pipe.

FIG. 11 is a flowchart used to describe the operation of a correction unit and the operation of a pressure calculation unit of the pressure sensor according to the first embodiment of the present disclosure.

FIG. 12 is a sectional view illustrating a pressure sensor according to a second embodiment of the present disclosure.

FIG. 13 is a plan view illustrating the pressure sensor according to the second embodiment of the present disclosure.

FIG. 14 is a sectional view illustrating the connection structure between the pressure sensor according to the second embodiment of the present disclosure and the pipe.

FIG. 15 is a sectional view illustrating the state in which the diaphragm of the pressure sensor has been deformed by the pressure of the fluid in the second embodiment of the present disclosure.

FIG. 16 is a sectional view illustrating the state in which the diaphragm and the dummy diaphragm of the pressure sensor have been deformed by the tightening force of the clamp in the second embodiment of the present disclosure.

FIG. 17 is a block diagram illustrating a structure example of a computer that realizes a determination unit of the pressure sensors according to the first and second embodiments of the present disclosure.

### DETAILED DESCRIPTION OF THE INVENTION

### [Principle of the Invention]

The inventors have found that the pressure measurement error due to disturbance can be corrected for by providing a diaphragm that is deformed by receiving the pressure of a fluid to be measured as well as a dummy diaphragm that is not deformed when receiving the pressure of a fluid and is deformed by the same disturbance as in the diaphragm, and detecting the deformation of the dummy diaphragm.

### First Embodiment

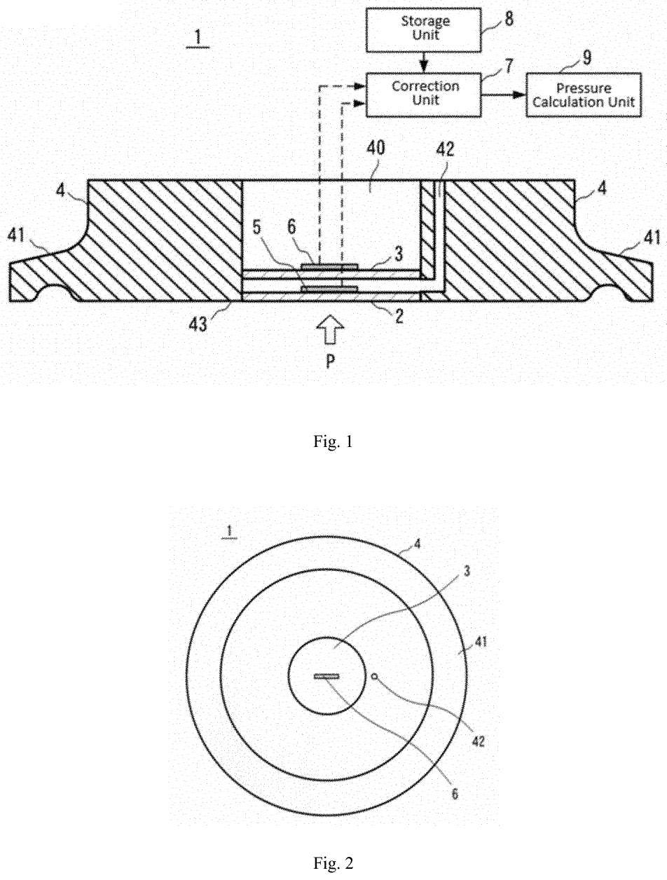

Embodiments of the present disclosure will be described below with reference to the drawings. FIG. 1 is a sectional view illustrating a pressure sensor according to a first embodiment of the present disclosure, and FIG. 2 is a plan view illustrating the pressure sensor.

A pressure sensor 1 detects a pressure P of a fluid to be measured by detecting the deformation of a diaphragm when the diaphragm is deflected by the pressure P of the fluid described above.

Specifically, the pressure sensor 1 includes a diaphragm 2 (first diaphragm) like a thin plate that receives the pressure of the fluid to be measured, a dummy diaphragm 3 (second diaphragm) like a thin plate that does not make contact with the fluid to be measured, a cylindrical housing 4 that is provided with a circular through-hole 40 opening to one end surface and the other end surface and supports a peripheral edge portion of the diaphragm 2 and a peripheral edge portion of the dummy diaphragm 3, a strain sensor 5 (first strain sensor) that detects the deformation of the diaphragm 2, a strain sensor 6 (second strain sensor) that detects the deformation of the dummy diaphragm 3, a correction unit 7 that corrects an output signal of the strain sensor 5 so as to eliminate the effect of disturbance based on an output signal of the strain sensor 6, a storage unit 8 that stores a correction formula in advance, and a pressure calculation unit 9 that converts the signal corrected by the correction unit 7 into the pressure of the fluid to be measured.

The cylindrical housing 4 in which the through-hole 40 is formed supports the peripheral edge portion of the diaphragm 2 and the peripheral edge portion of the dummy diaphragm 3. However, the shape of the housing 4 is not limited to a cylinder and may be, for example, a rectangular cylinder. The housing 4 is made of, for example, highly corrosion-resistant stainless steel (SUS), but may be made of another highly corrosion-resistant material such as ceramics or titanium. As illustrated in FIG. 1 and FIG. 2, a ferrule flange portion 41 projecting radially outward is provided at the outer peripheral edge of the housing 4 on the joint side (lower side in FIG. 1) coupled to a pipe.

In contrast, the end portion of the housing 4 on the opposite side (upper side in FIG. 1) of the joint side coupled to the pipe opens to the atmospheric pressure, and the inside of the through-hole 40 is filled with air. In addition, the housing 4 is provided with an atmospheric pressure introduction path 42 through which the atmospheric pressure is introduced into the space between the diaphragm 2 and the dummy diaphragm 3. The reason for introducing the atmospheric pressure in the space between the diaphragm 2 and the dummy diaphragm 3 is to eliminate the effects of the expansion and contraction of the air in this space and fluctuations in the atmospheric pressure. Accordingly, when the effects of the expansion and contraction of the air and fluctuations in the atmospheric pressure on the pressure measurement value are small or when the space is vacuum-sealed, the atmospheric pressure introduction path does not need to be provided.

The diaphragm 2 receives the pressure P from the fluid to be measured. The diaphragm 2 is made of, for example, stainless steel (SUS) formed in a circular thin plate in plan view, but may be made of another material such as ceramics or titanium. In addition, the shape of the diaphragm 2 is not limited to a circle, and may be, for example, a square in plan view.

The lower surface of the diaphragm 2 is the fluid contact surface (first surface) that receives the pressure P while being in contact with the fluid, and the upper surface of the diaphragm 2 is the deformation measurement surface (second surface) on which the strain sensor 5 is provided. The upper surface of the diaphragm also functions as the pressure receiving surface that receives the atmospheric pressure. The diaphragm 2 is fixed to an end portion 43 of the housing 4 on the joint side coupled to the pipe and blocks the through-hole 40 of the housing 4. The outer peripheral edge of the diaphragm 2 is joined to the wall surface of the through-hole 40 without a gap.

The dummy diaphragm 3 is made of, for example, SUS formed in a circular thin plate in plan view, but may be made of another material such as ceramics or titanium, as the diaphragm 2. The shape of the dummy diaphragm 3 is not limited to a circle, and may be, for example, a square or a rectangle in plan view, a shape having irregularities, a shape having cavities, a structure including a plurality of layers, or a structure including different materials.

The lower surface (first surface) and the upper surface (second surface) of the dummy diaphragm 3 function as pressure receiving surfaces that receive the atmospheric pressure. The upper surface of the dummy diaphragm 3 is the deformation measurement surface on which the strain sensor 6 is provided. However, the strain sensor 6 may be provided on the lower surface of the dummy diaphragm 3. The dummy diaphragm 3 is provided in the through-hole 40 of the housing 4 so that the lower surface thereof faces the upper surface of the diaphragm 2. The outer peripheral edge of the dummy diaphragm 3 is joined to the wall surface of the through-hole 40 without a gap.

The strain sensor 5 detects the deformation of the diaphragm 2 and the strain sensor 6 detects the deformation of the dummy diaphragm 3. The strain sensors 5 and 6 contain semiconductor chips, respectively. A strain gauge that outputs a signal according to the deformation of the diaphragm 2 is formed in the semiconductor chip of the strain sensor 5. Similarly, a strain gauge that outputs a signal according to the deformation of the dummy diaphragm 3 is formed in the semiconductor chip of the strain sensor 6. Since such strain gauges are disclosed in PTL 1, PTL 2, PTL 3, and PTL 4, detailed description is omitted. It should be noted here that the strain sensors 5 and 6 are not limited to the semiconductor strain gauge type, and may be, for example, the capacitance type, the metal strain gauge type, or the type in which a resistance gauge is formed as a film by sputtering or the like.

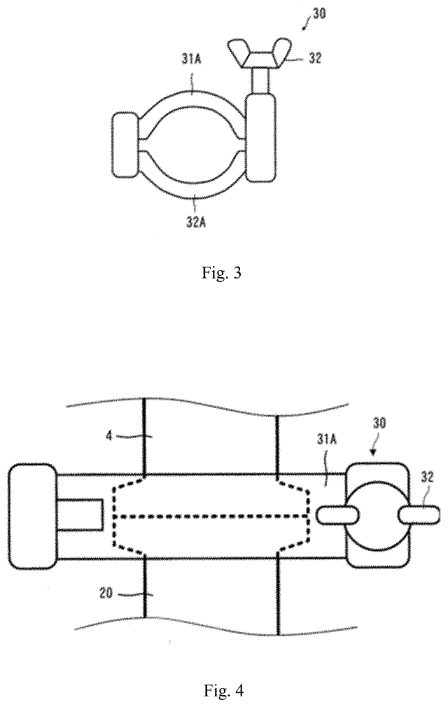

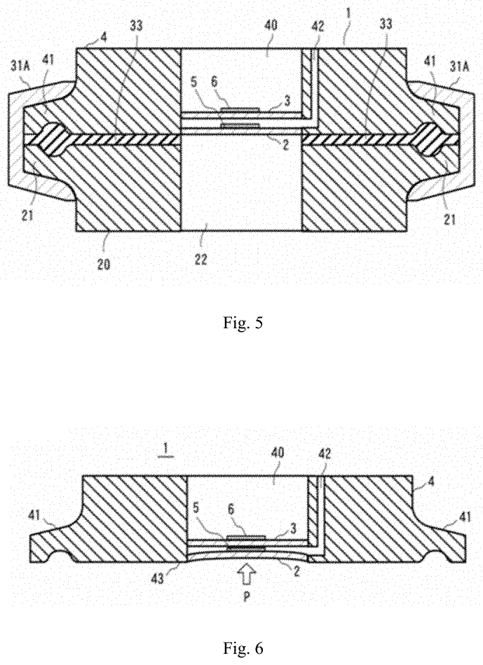

FIG. 3 is an external view illustrating a clamp for attaching the pressure sensor 1 to a pipe 20, FIG. 4 is an external view illustrating the connection structure between the pressure sensor 1 and the pipe 20, and FIG. 5 is a sectional view illustrating the connection structure between the pressure sensor 1 and the pipe 20.

When the pressure sensor 1 is connected to the cylindrical pipe 20, a clamp 30 as illustrated in FIG. 3 is used. Specifically, a ferrule flange portion 21 of the pipe 20 and the ferrule flange portion 41 of the housing 4 are connected to each other by disposing the ferrule flange portion 21 of the pipe 20 and the ferrule flange portion 41 of the housing 4 so that these portions face each other as illustrated in FIG. 4 and FIG. 5, sandwiching the two ferrule flange portions 21 and 41 between annular fixing portions 31A and 32A of the clamp 30, and tightening the fixing portions 31A and 32A with a screw 32. In addition, a gasket 33 for preventing leakage is disposed between the ferrule flange portion 21 and the ferrule flange portion 41 connected by the clamp 30. The fluid to be measured reaches the lower surface (fluid contact surface) of the diaphragm 2 through a through-hole 22 of the pipe 20. It should be noted here that connection between the pressure sensor 1 and the cylindrical pipe 20 is not limited to use of the ferrule clamp joint structure, and other joint types (such as a screw mount and a bag nut) may be used.

In the embodiment, it is desirable that the output signal of the strain sensor 5 substantially coincides with the output signal of the strain sensor 6 when the diaphragm 2 does not receive the pressure P of the fluid. To make the output signal of the strain sensor 5 substantially coincide with the output signal of the strain sensor 6, it is desirable that, for example, the diameter and the thickness of the diaphragm 2 are the same as the diameter and the thickness of the dummy diaphragm 3, and the structure of the strain sensor 5 is the same as the structure of the strain sensor 6. In addition, it is desirable that the mounting position of the strain sensor 5 within the surface of the diaphragm 2 coincides with the mounting position of the strain sensor 6 within the surface of the dummy diaphragm 3, and the distance between the diaphragm 2 and the dummy diaphragm 3 is desirably as small as possible.

However, even if the output signal of the strain sensor 5 does not substantially coincide with the output signal of strain sensor 6, the present disclosure is applicable when a correlation is clearly present between the output signal of the strain sensor 5 and the output signal of the strain sensor 6 as described later.

Next, the characteristic operation of the present disclosure will be described. Since the pressure P of the fluid is applied only to the diaphragm 2 and not applied to the dummy diaphragm 3, only the strain sensor 5 responds according to the pressure P.

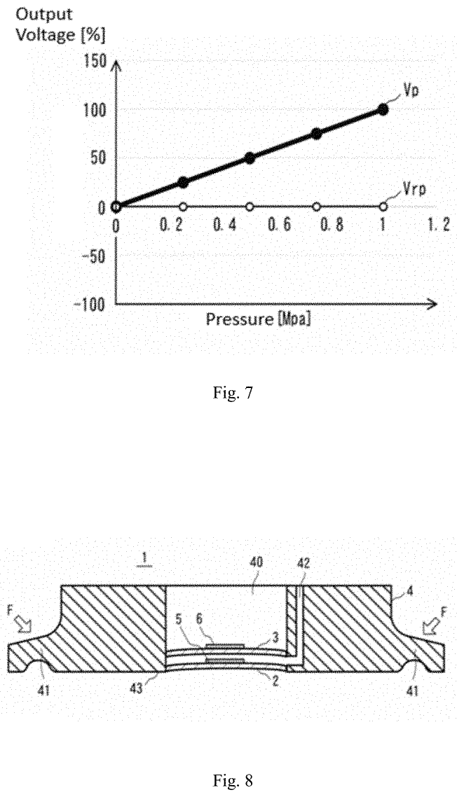

FIG. 6 is a sectional view illustrating the state in which the diaphragm 2 has been deformed by the pressure P of the fluid, and FIG. 7 is a diagram illustrating changes in the output signals of the strain sensors 5 and 6 with respect to the pressure P of the fluid. In FIG. 7, the output signal of the strain sensor 5 with respect to the pressure P of the fluid is indicated by Vp, and the output signal of the strain sensor 6 with respect to the pressure P of the fluid is indicated by Vrp. It should be noted here that the vertical axis of the graph in FIG. 7 represents the magnitudes of the output signals Vp and Vrp of the strain sensors 5 and 6 as normalized voltages obtained by assuming a predetermined maximum value FS (full scale) to be 100%. The same notation is used in the graphs that follow.

As is clear from FIG. 7, the output signal Vp of the strain sensor 5 changes according to the pressure P of the fluid, but the output signal Vrp of the strain sensor 6 becomes constant with respect to the pressure P since the dummy diaphragm 3 is not deformed.

In contrast, since the entire housing 4 is bent by the tightening force of the clamp 30 when the housing 4 of the pressure sensor 1 and the pipe 20 are tightened by the clamp 30, the diaphragm 2 and the dummy diaphragm 3 are deformed equally. Accordingly, the output signal of the strain sensor 5 and the output signal of the strain sensor 6 make substantially identical responses or responses having a correlation.

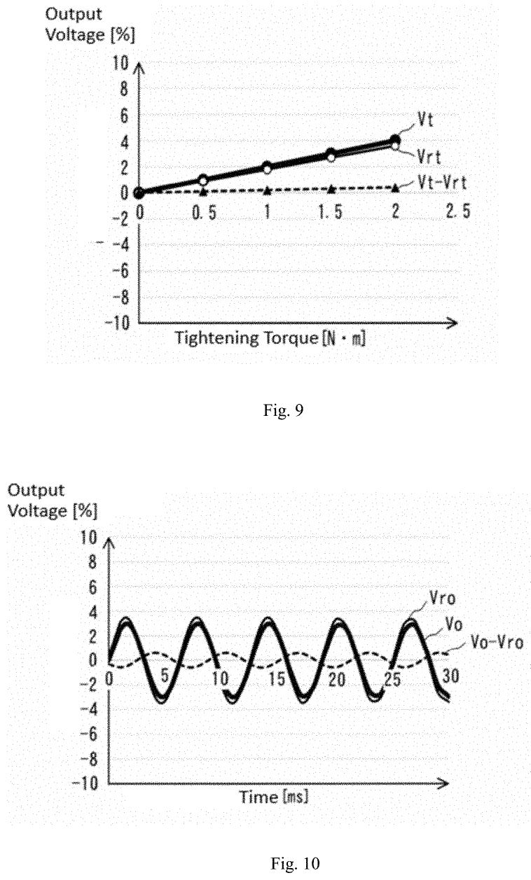

FIG. 8 is a sectional view illustrating the state in which the diaphragm 2 and the dummy diaphragm 3 have been deformed by a tightening force F of the clamp 30, and FIG. 9 is a diagram illustrating changes in the output signals of the strain sensors 5 and 6 with respect to the tightening torque of the clamp 30. In FIG. 9, the output signal of the strain sensor 5 with respect to the tightening torque of the clamp 30 is indicated by Vt, and the output signal of the strain sensor 6 with respect to the tightening torque of the clamp 30 is indicated by Vrt. In the example in FIG. 9, the output signal Vt of the strain sensor 5 and the output signal Vrt of the strain sensor 6 make substantially identical responses with respect to the tightening torque of the clamp 30.

In addition, when vibrations of the pipe 20 are transmitted to the pressure sensor 1, the diaphragm 2 is deformed so as to bend up and down according to the natural frequencies of the diaphragm 2 and the strain sensor 5 while the dummy diaphragm 3 is deformed so as to bend up and down according to the natural frequencies of the dummy diaphragm 3 and the strain sensor 6. Accordingly, the output signal of the strain sensor 5 and the output signal of the strain sensor 6 make substantially identical responses or responses having a correlation.

FIG. 10 is a diagram illustrating changes in the output signals of the strain sensors 5 and 6 with respect to the vibrations of the pipe 20. In FIG. 10, the output signal of the strain sensor 5 with respect to the vibrations of the pipe 20 is indicated by Vo, and the output signal of the strain sensor 6 with respect to the vibrations of the pipe 20 is indicated by Vro. It can be seen from the example in FIG. 10 that the output signal Vo of the strain sensor 5 and the output signal Vro of the strain sensor 6 fluctuate periodically, and the output signal Vo of the strain sensor 5 and the output signal Vro of the strain sensor 6 make substantially identical responses with respect to the vibrations of the pipe 20.

Next, the method for correcting the pressure measurement value will be described.

### [Case 1]

When the output signal of the strain sensor 5 and the output signal of the strain sensor 6 make substantially identical responses for both the disturbance of the tightening force of the clamp 30 and the vibrations of the pipe 20, Vrt≅Vt and Vro≅Vo hold. In addition, when the output signal of the strain sensor 6 is Vr, the output signal Vr is represented by the following formula.

Vr=Vrt+Vro (1)

When the output error of the strain sensor 5 due to the disturbance received by the strain sensor 5 is Verr, the output signal V of the strain sensor 5 is represented by the following formula.

V=Vp+Verr (2)

When the output signal of the strain sensor 5 corrected by the embodiment is Vc, the following formula holds.

Vc=Vp=V−Verr=V−(Vt+Vo)=V−(Vrt+Vro)=V−Vr (3)

FIG. 11 is a flowchart used to describe the operation of the correction unit 7 and the operation of the pressure calculation unit 9. As illustrated in formula (3), the correction unit 7 corrects the output signal of the strain sensor 5 by subtracting the output signal Vr of the strain sensor 6 from the output signal V of the strain sensor 5 (step S100 in FIG. 11). The data table in which the output signal Vr of the strain sensor 6 is associated with the correction amount or formula (3) used by the correction unit 7 is preset in the storage unit 8. In this way, the corrected output signal Vc (the output signal of the strain sensor 5 excluding the effect of disturbance) can be calculated.

In the pressure calculation unit 9, a conversion formula including the corrected output signal Vc of the strain sensor 5 as a variable or a table for storing the association between the corrected output signal Vc of the strain sensor 5 and the pressure P is preset. The pressure calculation unit 9 converts the corrected output signal Vc of the strain sensor 5 into the pressure P of the fluid via the conversion formula or the table (step S101 in FIG. 11).

The correction unit 7 and the pressure calculation unit 9 repeatedly execute the processing of step S100 and the processing of step S101 until the pressure measurement processing is completed according to, for example, an instruction from the user (YES in step S102 in FIG. 11).

As described above, in the embodiment, even when the pressure sensor 1 is affected by a plurality of types of disturbance, the effect of disturbance on the pressure measurement value can be corrected for by subtracting the output signal Vr of the strain sensor 6 from the output signal V of the strain sensor 5.

When the output signal Vr of the strain sensor 6 falls outside a predetermined allowable range, the correction unit 7 may correct the output signal of the strain sensor 5 using formula (3) by determining that the reliability of the pressure measurement value has been impaired. When the output signal Vr of the strain sensor 6 falls within the allowable range, the correction unit 7 may not need to change the output signal of the strain sensor 5 by determining that the reliability of the pressure measurement value has been maintained. When the correction unit 7 does not correct the output signal, the pressure calculation unit 9 converts the output signal V of the strain sensor 5 into the pressure. The tolerance range is −TH≤Vr≤TH when the tolerance threshold of the pressure measurement error due to the effect of disturbance is TH. The tolerance threshold TH is set to, for example, 2% FS when the predetermined maximum value FS (full scale) of the signal is 100%.

### [Case 2]

Next, the following describes the case in which the output signal of the strain sensor 5 does not coincide with the output signal of the strain sensor 6, but makes responses having a correlation. It is assumed that the output signal Vt of the strain sensor 5 with respect to the tightening torque of the clamp 30 is represented by the following formula.

Vt=a×Vrt+b (4)

Here, a and b are constants. In addition, it is assumed that the output signal Vo of the strain sensor 5 with respect to the vibrations of the pipe 20 is represented by the following formula.

Vo=c×Vro+d (5)

Here, c and d are constants. The output signal Vr of the strain sensor 6 is represented by formula (1) as in the case described above.

When the output signal of the strain sensor 5 corrected by the embodiment is Vc, the following formula holds.

Vc=V−(Vt+Vo)=V−(a×Vrt+b+c×Vro+d) (6)

Here, when it can be determined that the pressure sensor 1 is affected by either the tightening force of the clamp 30 or the vibrations of the pipe 20, for example, when the pressure sensor 1 is affected only by the tightening force of the clamp 30, the following formula holds because the output signal Vro of the strain sensor 6 with respect to the vibrations of the pipe 20 is 0 and Vrt equals Vr.

Vc=V−a×Vr−b−d (7)

By setting formula (7) in the storage unit 8 instead of formula (3), the correction unit 7 can calculate the corrected output signal Vc of the strain sensor 5 as in case 1.

Similarly to the above, the correction unit 7 may correct the output signal of the strain sensor 5 using formula (7) only when the output signal Vr of the strain sensor 6 falls outside an allowable range. When it is assumed that the reliability of the pressure measurement value is maintained if the output error Verr of the strain sensor 5 due to disturbance is equal to or less than 2% FS, the tolerance threshold TH is (2−b−d)/a when the pressure sensor 1 is affected only by the tightening force of the clamp 30.

Alternatively, when the pressure sensor 1 is affected only by the vibrations of the pipe 20, the output signal Vrt of the strain sensor 6 with respect to the tightening torque of the clamp 30 is 0 and Vro equals Vr, so the following formula holds.

Vc=V−b−c×Vr−d (8)

By setting formula (8) in the storage unit 8 instead of formula (3), the correction unit 7 can calculate the corrected output signal Vc of the strain sensor 5 as in case 1.

Similarly to the above, the correction unit 7 may correct the output signal of the strain sensor 5 using formula (8) only when the output signal Vr of the strain sensor 6 falls outside an allowable range. When it is assumed that the reliability of the pressure measurement value is maintained if the output error Verr of the strain sensor 5 due to disturbance is equal to or less than 2% FS, the tolerance threshold TH is (2−b−d)/c when the pressure sensor 1 is affected only by the vibrations of the pipe 20.

Alternatively, when the pressure sensor 1 is affected by both the tightening force of the clamp 30 and the vibrations of the pipe 20, the correction formula can be derived by obtaining the relational formula between the output signal Vrt of the strain sensor 6 with respect to the tightening torque of the clamp 30 and the output signal Vro of the strain sensor 6 with respect to the vibrations of the pipe 20. For example, when the relationship Vrt=e×Vro is present, the following formula holds.

$$\begin{matrix}Vc = V - ( a \times e + c ) \times Vro - d \\ = V - \{ ( a \times e + c ) / ( e + 1 ) \} \times V r - d\end{matrix} \qquad ( 9 )$$

As described above, a, c, d, and e are constants. By setting formula (9) in the storage unit 8 instead of formula (3), the correction unit 7 can calculate the corrected output signal Vc of the strain sensor 5 as in case 1.

Similarly to the above, the correction unit 7 may correct the output signal of the strain sensor 5 using formula (9) only when the output signal Vr of the strain sensor 6 falls outside an allowable range. When it is assumed that the reliability of pressure measurement value is maintained if the output error Verr of the strain sensor 5 due to disturbance is equal to or less than 2% FS, the tolerance threshold TH is (2−b−d)×(e+1)/(a×e+c) when the pressure sensor 1 is affected by both the tightening force of the clamp 30 and the vibrations of the pipe 20.

It should be noted here that, when the pressure sensor 1 is affected by the vibrations of the pipe 20, it is possible to obtain the correction formula for calculating the output signal Vc based on the periodicity of the output signal of the strain sensor 6 in a preliminary test in which the same type of pressure sensor is attached to the pipe 20. In addition, when the pressure sensor 1 is affected by the tightening force of the clamp 30, it is possible to obtain the correction formula for calculating the output signal Vc by obtaining the output signal of the strain sensor 6 in a preliminary attachment test in which the same type of pressure sensor is attached to the pipe 20.

### Second Embodiment

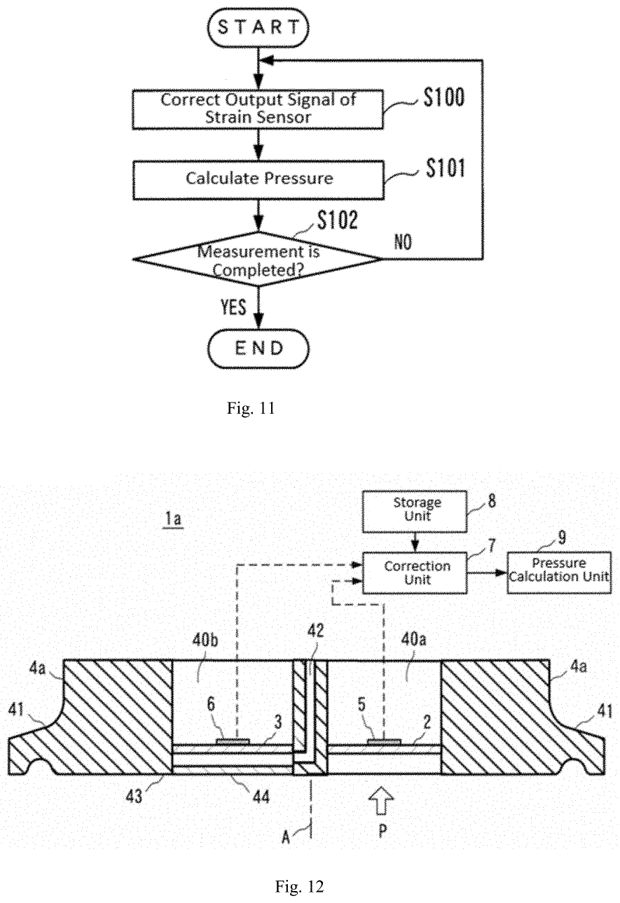

Next, a second embodiment of the present disclosure will be described. FIG. 12 is a sectional view illustrating a pressure sensor according to the second embodiment of the present disclosure, and FIG. 13 is a plan view illustrating the pressure sensor. A pressure sensor 1a according to the embodiment includes the diaphragm 2, the dummy diaphragm 3, a housing 4a, the strain sensor 5, the strain sensor 6, the correction unit 7, the storage unit 8, and the pressure calculation unit 9.

A circular through-hole 40a (first through-hole) and a circular through-hole 40b (second through-hole) are formed in parallel with each other in the housing 4a. The housing 4a is made of, for example, SUS, but may be made of another material such as ceramics or titanium, as the housing 4. The ferrule flange portion 41 projecting radially outward is provided at the outer peripheral edge of the housing 4a on the joint side (lower side in FIG. 12) coupled to the pipe.

The end portion of the housing 4a on the opposite side (upper side in FIG. 12) of the joint side coupled to the pipe opens to the atmospheric pressure, and the insides of the through-holes 40a and 40b are filled with air. In addition, the housing 4a is provided with the atmospheric pressure introduction path 42 through which the atmospheric pressure is introduced into the space between the dummy diaphragm 3 and a barrier 44 described later.

The diaphragm 2 is made of, for example, SUS, but may be made of another material such as ceramics or titanium. The lower surface of the diaphragm 2 is the fluid contact surface (first surface) that receives the pressure P while being in contact with the fluid to be measured, and the upper surface of the diaphragm 2 is the deformation measurement surface (second surface) on which the strain sensor 5 is provided. The upper surface of the diaphragm 2 also functions as the pressure receiving surface that receives the atmospheric pressure. The diaphragm 2 is fixed to the vicinity of the end portion 43 of the housing 4a on the joint side coupled to the pipe and blocks the through-hole 40a of the housing 4a. The outer peripheral edge of the diaphragm 2 is joined to the wall surface of the through-hole 40a without a gap.

The dummy diaphragm 3 is made of, for example, SUS, but may be made of another material such as ceramics or titanium, as the diaphragm 2. The lower surface (first surface) and the upper surface (second surface) of the dummy diaphragm 3 function as the pressure receiving surfaces that receive the atmospheric pressure. The upper surface of the dummy diaphragm 3 is the deformation measurement surface on which the strain sensor 6 is provided. As in the first embodiment, the strain sensor 6 may be provided on the lower surface of the dummy diaphragm 3. The dummy diaphragm 3 is fixed to the vicinity of the end portion 43 of the housing 4a on the joint side coupled to the pipe and blocks the through-hole 40b of the housing 4a. The outer peripheral edge of the dummy diaphragm 3 is joined to the wall surface of the through-hole 40b without a gap.

In addition, the pressure sensor 1a according to the embodiment is provided with the barrier 44 (blocking member) that blocks the end of the through-hole 40b on the joint side coupled to the pipe and has the lower surface (first surface) in contact with the fluid to be measured. The barrier 44 is made of, for example, SUS, but may be made of another material such as ceramics or titanium, as the diaphragm 2 and the dummy diaphragm 3. The outer peripheral edge of the barrier 44 is joined to the wall surface of the through-hole 40b without a gap.

Although the diaphragm 2 and the dummy diaphragm 3 may be joined to the housing 4a as described above, another manufacturing method can be selected in the embodiment. Specifically, cutting work is applied to the housing 4a so that the portions of the diaphragm 2 and the dummy diaphragm 3 remain in the through-holes 40a and 40b of the housing 4a. Then, the barrier 44 only needs to be welded to the inner wall of the through-hole 40b.

The strain sensors 5 and 6, the correction unit 7, the storage unit 8, and the pressure calculation unit 9 are the same as in the first embodiment.

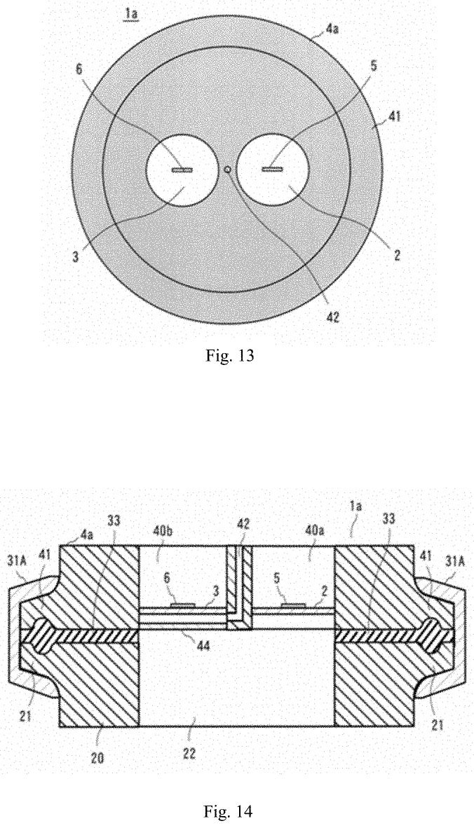

FIG. 14 is a sectional view illustrating the connection structure between the pressure sensor 1a and the pipe 20. When the pressure sensor 1a is connected to the pipe 20, as illustrated in FIG. 14, the ferrule flange portion 21 of the pipe 20 and the ferrule flange portion 41 of the housing 4a are disposed so as to face each other, the two ferrule flange portions 21 and 41 are sandwiched between the annular fixing portions 31A and 32A of the clamp 30 as in the first embodiment, and the fixing portions 31A and 32A are fastened with the screw 32 to connect the ferrule flange portion 21 and the ferrule flange portion 41 to each other. The fluid to be measured reaches the lower surface (fluid contact surface) of the diaphragm 2 through the through-hole 22 of the pipe 20.

It is desirable that the output signal of the strain sensor 5 substantially coincides with the output signal of the strain sensor 6 when the diaphragm 2 does not receive the pressure P of the fluid, as in the first embodiment. To make the output signal of the strain sensor 5 substantially coincide with the output signal of the strain sensor 6, it is desirable that, for example, the diameter and the thickness of the diaphragm 2 are the same as the diameter and the thickness of the dummy diaphragm 3, and the structure of the strain sensor 5 is the same as the structure of the strain sensor 6. In addition, it is desirable that the mounting position of the strain sensor 5 within the surface of the diaphragm 2 coincides with the mounting position of the strain sensor 6 within the surface of the dummy diaphragm 3, the formation positions in the longitudinal direction (vertical direction in FIG. 12) of the housing 4a of the diaphragm 2 and the dummy diaphragm 3 coincide with each other (the position of the diaphragm 2 from the end surface of the housing 4a coincides with the position of the dummy diaphragm 3 from the end surface of the housing 4a), and the diaphragm 2 and the dummy diaphragm 3 are disposed symmetrically with each other about the axis of the housing 4a (A in FIG. 12).

Furthermore, it is desirable to reduce the rigidity of the barrier 44 with respect to the diaphragm 2 and the dummy diaphragm 3 (for example, reduce the plate thickness) so as to reduce the difference in the mounting effects on the diaphragm 2 and the dummy diaphragm 3. However, even if the output signal of the strain sensor 5 does not substantially coincide with the output signal of the strain sensor 6, the present disclosure is applicable when a correlation is clearly present between the output signal of the strain sensor 5 and the output signal of the strain sensor 6 as in the first embodiment.

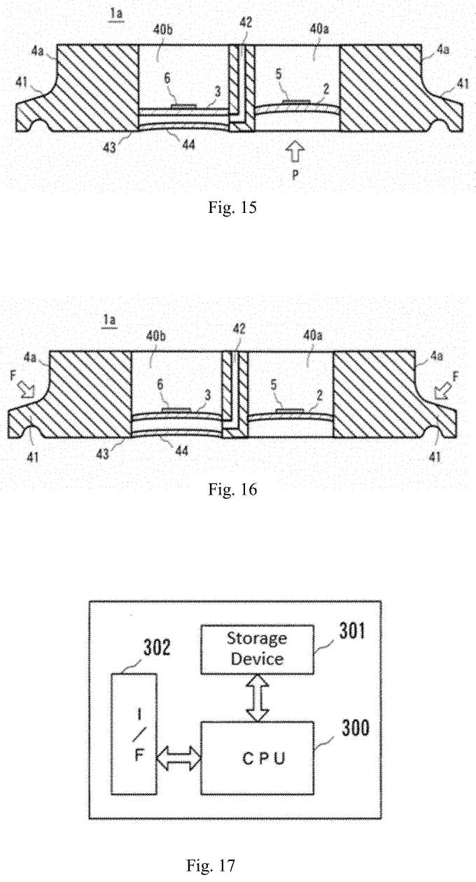

FIG. 15 is a sectional view illustrating the state in which the diaphragm 2 and the barrier 44 have been deformed by the pressure P of the fluid, and FIG. 16 is a sectional view illustrating the state in which the diaphragm 2, the dummy diaphragm 3, and the barrier 44 have been deformed by the tightening force F of the clamp 30. When the vibrations of the pipe 20 are transmitted to the pressure sensor 1a, the diaphragm 2 is deformed so as to bend up and down according to the natural frequencies of the diaphragm 2 and the strain sensor 5 while the dummy diaphragm 3 is deformed so as to bend up and down according to the natural frequencies of the dummy diaphragm 3 and the strain sensor 6.

Since the operations of the correction unit 7 and the pressure calculation unit 9 are the same as those in the first embodiment, the description is omitted.

Accordingly, in the embodiment, the same effect as in the first embodiment can be obtained. Although the tightening force of the clamp 30 and the vibrations of the pipe 20 are taken as examples of disturbance in the first and second embodiments, when the strain sensors 5 and 6 are affected substantially similarly by disturbance such as, for example, the temperature, humidity, light, and electromagnetic field, the present disclosure is applicable.

The correction unit 7, the storage unit 8, and the pressure calculation unit 9 according to the first and second embodiments can be realized by a computer. A structure example of the computer is illustrated in FIG. 17. The computer includes a CPU (central processing unit) 300, a storage device 301, and an interface device (I/F) 302. The strain sensors 5 and 6 and the like are connected to the I/F 302. In the computer described above, the program for achieving the pressure calculation method according to the present disclosure is stored in the storage device 301. The CPU 300 executes the processes described in the first and second embodiments according to the program stored in the storage device 301.

### INDUSTRIAL APPLICABILITY

The present disclosure is applicable to pressure sensors.

### DESCRIPTION OF REFERENCE NUMERALS AND SIGNS

1, 1a: pressure sensor, 2: diaphragm, 3: dummy diaphragm, 4, 4a: housing, 5, 6: strain sensor, 7: correction unit, 8: storage unit, 9: pressure calculation unit, 20: pipe, 21, 41: ferrule flange portion, 22, 40, 40a, 40b: through-hole, 42: atmospheric pressure introduction path, 44: barrier

1. A pressure sensor comprising:
a cylindrical housing in which an opening is present in at least one end surface;
a first diaphragm that has a peripheral edge portion fixed to an inner wall of the housing so as to block the opening and has a first surface configured to face and be in contact with a fluid to be measured;
a first strain sensor configured to detect deformation of the first diaphragm, the first strain sensor being provided on a second surface on an opposite side of the first surface of the first diaphragm;
a second diaphragm that has a peripheral edge portion fixed to the inner wall of the housing and has a first surface configured to face towards the fluid and a second surface on an opposite side of the first surface, the first surface and the second surface configured to be not in contact with the fluid;
a second strain sensor configured to detect deformation of the second diaphragm, the second strain sensor being provided on the first surface or the second surface of the second diaphragm;
a correction unit configured to correct an output signal of the first strain sensor so as to eliminate an effect of disturbance based on an output signal of the second strain sensor; and
a pressure calculation unit configured to convert the signal corrected by the correction unit into a pressure of the fluid.

2. The pressure sensor according to claim 1,
wherein the second diaphragm is provided in the housing so that the first surface of the second diaphragm faces the second surface of the first diaphragm.

3. The pressure sensor according to claim 2,
wherein the housing further includes an atmospheric pressure introduction path through which an atmospheric pressure is introduced into a space between the first diaphragm and the second diaphragm.

4. The pressure sensor according to claim 1, further comprising:
a blocking member that blocks a second opening of the housing and has a first surface configured to be in contact with the fluid, the housing being provided with, as the opening, a first opening and the second opening in parallel with each other;
wherein
the first diaphragm has the peripheral edge portion fixed to the inner wall of the housing so as to block the first opening, and
the second diaphragm is provided inside the second opening so that the first surface of the second diaphragm faces a second surface on an opposite side of the first surface of the blocking member.

5. The pressure sensor according to claim 4,
wherein the housing further includes an atmospheric pressure introduction path through which an atmospheric pressure is introduced into a space between the second diaphragm and the blocking member.

6. The pressure sensor according to claim 4, wherein
a position of the first diaphragm from the one end surface of the housing in the first opening coincides with a position of the second diaphragm from the one end surface of the housing in the second opening, and
the first diaphragm and the second diaphragm are disposed symmetrically with each other about an axis of the housing.

7. The pressure sensor according to claim 5, wherein
a position of the first diaphragm from the one end surface of the housing in the first opening coincides with a position of the second diaphragm from the one end surface of the housing in the second opening, and
the first diaphragm and the second diaphragm are disposed symmetrically with each other about an axis of the housing.

8. The pressure sensor according to claim 2,
wherein the first diaphragm and the second diaphragm have the same diameter and the same thickness.

9. The pressure sensor according to claim 3,
wherein the first diaphragm and the second diaphragm have the same diameter and the same thickness.

10. The pressure sensor according to claim 4,
wherein the first diaphragm and the second diaphragm have the same diameter and the same thickness.

11. The pressure sensor according to claim 5,
wherein the first diaphragm and the second diaphragm have the same diameter and the same thickness.

12. The pressure sensor according to claim 2,
wherein, when the output signal of the first strain sensor is V, the output signal of the second strain sensor is Vr, and the corrected output signal is Vc, the correction unit calculates the corrected output signal Vc by Vc=V−Vr or Vc=V+Vr.

13. The pressure sensor according to claim 4,
wherein, when the output signal of the first strain sensor is V, the output signal of the second strain sensor is Vr, and the corrected output signal is Vc, the correction unit calculates the corrected output signal Vc by Vc=V−Vr or Vc=V+Vr.

14. The pressure sensor according to claim 2,
wherein, when the output signal of the first strain sensor is V, the output signal of the second strain sensor is Vr, and the corrected output signal is Vc, the correction unit calculates the corrected output signal Vc by Vc=V−a×Vr−b−d (where a, b, and d are constants).

15. The pressure sensor according to claim 4,
wherein, when the output signal of the first strain sensor is V, the output signal of the second strain sensor is Vr, and the corrected output signal is Vc, the correction unit calculates the corrected output signal Vc by Vc=V−a×Vr−b−d (where a, b, and d are constants).

16. The pressure sensor according to claim 2,
wherein, when the output signal of the first strain sensor is V, the output signal of the second strain sensor is Vr, and the corrected output signal is Vc, the correction unit calculates the corrected output signal Vc by Vc=V−b−c×Vr−d (where b, c, and d are constants).

17. The pressure sensor according to claim 4,
wherein, when the output signal of the first strain sensor is V, the output signal of the second strain sensor is Vr, and the corrected output signal is Vc, the correction unit calculates the corrected output signal Vc by Vc=V−b−c×Vr−d (where b, c, and d are constants).

18. The pressure sensor according to claim 2,
wherein, when the output signal of the first strain sensor is V, the output signal of the second strain sensor is Vr, and the corrected output signal is Vc, the correction unit calculates the corrected output signal Vc by Vc=V−{(a×e+c)/(e+1)}×Vr−d (where a, c, d, and e are constants).

19. The pressure sensor according to claim 4,
wherein, when the output signal of the first strain sensor is V, the output signal of the second strain sensor is Vr, and the corrected output signal is Vc, the correction unit calculates the corrected output signal Vc by Vc=V−{(a×e+c)/(e+1)}×Vr−d (where a, c, d, and e are constants).
